(19) United States
(12) Patent Application Publication
(10) Pub. No.: US 2015/0076800 A1
(43) Pub. Date: Mar. 19, 2015

(54) REBUILDABLE UTILITY TRAILER

(71) Applicant: Randy Davis, Abilene, TX (US)

(72) Inventor: Randy Davis, Abilene, TX (US)

(21) Appl. No.: 14/031,671

(22) Filed: Sep. 19, 2013

(51) Int. Cl. B62D 63/06

(52) U.S. Cl. CPC B62D 63/061
USPC 280/656; 296/183.1; 29/897.2

(57) ABSTRACT

A trailer includes a first side railing with a first stand and a second stand along with a second side railing with a third stand and a fourth stand. A front railing is removably attached to the first side railing and the second side railing. The method includes joining the front railing to the first side railing and the second side railing, then raising the front railing, the first side railing, and the second side railing with the stands and then removably attaching a wheel assembly to the first side railing and the second side railing.

### BACKGROUND

1. Field of the Invention

The present application relates generally to vehicle-towed trailers, and more specifically, to a rebuildable utility trailer configured for multiple disassembly and reassembly.

2. Description of Related Art

Utility trailers are well known in the art for effectively providing cargo space to haul various items, e.g., motorcycles, lawn equipments, debris, cars, and the like. After use, the utility trail is stored, and the storage process includes detaching the utility trailer from the towing vehicle and thereafter storing the trailer in a desired location such as, for example, a car garage. Due to the trailer size and bulkiness, the storage area is greatly limited for other use such as parking a car. One common solution to overcome the storage issue is to rent or purchase additional storage space; however, this solution increases the overall cost to own and operate a trailer.

A foldable trailer is another solution that partially overcomes the problems associated with storing a trailer. However, even foldable trailers require substantial storage space due to the bulkiness of a trailer when folded. Thus, foldable trailers fail to adequately overcome the above-mentioned problems commonly associated with storing trailers.

Although the foregoing developments in trailers represent great strides, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is an oblique view of a trailer according to a preferred embodiment of the present application;

FIG. 2 is a side view of the trailer of FIG. 1;

FIG. 3 is a top view of the trailer of FIG. 1;

FIG. 4 is a bottom view of the trailer of FIG. 1;

FIG. 5 is a partial side view of a side railing and a front railing taken at V-V of FIG. 3;

FIG. 6 is a partial top view of a crossbeam support taken at VI-VI of FIG. 4;

FIG. 7 is a side view of a crossbeam support taken at VII-VII of FIG. 6;

FIG. 8 is a front view of a horizontal support taken at VIII-VIII of FIG. 4;

FIGS. 9A-9C are top views of a locking mechanism; and

FIGS. 10A-10C are side views of the locking mechanism of FIGS. 9A-9C.

While the trailer and method of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the trailer and method of use are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The trailer of the present application overcomes the above-listed problems commonly associated with conventional trailers. Specifically, the trailer disassembles prior to storage, and then easily reassembles prior to re-use. When disassembled, the trailer greatly reduces the required storages space. For example, the trailer can be stored on shelving within the storage facility, thereby allowing storage for other vehicles or items that cannot be disassembled, e.g., the towing vehicles. In order to achieve this feature, the trailer is configured to be easily and rapidly disassembled and reassembled via a plurality of fasteners and/or quick-release devices. Further detailed description of these features are provided below and illustrated in the accompanying drawings.

The trailer and method of use of the present application will be understood, both as to its structure and operation, from the accompanying drawings, taken in conjunction with the accompanying description. Several embodiments of the trailer are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

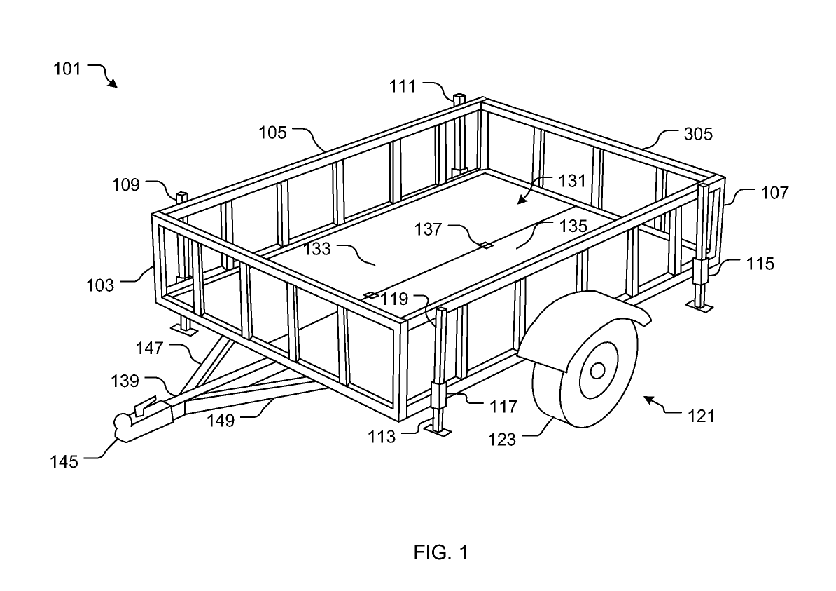

Referring now to the drawings wherein like reference characters identify corresponding or similar elements throughout the several views, FIGS. 1-4 depict various views of a rebuildable trailer 101 in accordance with a preferred embodiment of the present application. It will be appreciated that trailer 101 can be manufactured in various sizes, for example, a 6×8 foot trailer, and is configured for use with different applications typical for utility trailers.

Trailer 101 preferably includes one or more of a front railing 103 removably attached to two side railings: a first side railing 105 and a second side railing 107. When assembled, front railing 103 is configured to retain first side railing 105 relatively parallel to second side railing 105. In the preferred embodiment, the railings are composed of a lightweight metallic material, preferably steel; however, alternative embodiments could include other suitable materials, such as aluminum, fiber composites, or the like in lieu of preferred material.

Trailer 101 is further provided with a plurality of footings, preferably four footings: a first footing 109 and second footing 111 secured to first railing 105, and a third footing 113 and a fourth footing 115 secured to second railing 107. In the preferred embodiment, the footings are configured to slidingly engage with a housing 117 in direction D1 (for ease of description and viewing, only footing is labeled; however, all footings share the same features). In the contemplated embodiment, housing 117 is rigidly attached to the railing; however, alternative embodiments could include housings that rotatably mount to the side railings. A shaft 119 is configured to slides within housing 117 and is then secured in a locked position via a locking device (not shown) to retain shaft 119 in an extended position. A pin-lock mechanism could be utilized in the preferred embodiment as a locking device to secure shaft 119. It will be appreciated that other embodiments of the footings are also contemplated, for example, footings that have shafts that telescopically extend in lieu of a shaft having a fixed length that slidingly engages within the housing.

One unique feature believed characteristic of trailer 101 is utilizing a lightweight wheel assembly 121 that removably attaches to first side railing 105 and second side railing 107. In the contemplated embodiment, wheel assembly 121 is fastened via one or more fasteners, e.g., bolts that can thereafter be removed during the disassembly process. It will be appreciated that wheel assembly 121 preferably includes two or more wheels 123, 124, an axial 125, and spring leafs associated with each wheel. The lightweight wheel assembly design enables rapid and easy disassembly from the side railings.

One or more crossbeams 127, 129 are removably attached to the side railings and are configured to retain the side railings in a relatively parallel position to each other. The crossbeams also provide means for securing a platform 131 to trailer 101. In the exemplary embodiment, platform 131 includes two sections 133, 135 that pivotally engage with each other about pivot joint 137. It will be appreciated that alternative platforms designs are also contemplated, which include wood planks, ramps, and the like in lieu of the preferred embodiment.

A horizontal beam 139 is removably attached to crossbeam 127 via a flange 141 and removably attached to front railing 103 via a flange 143. In the contemplated embodiment, flanges 141, 143 are shaped to slidingly receive horizontal beam 139. A tongue 145 is rigidly attached to one end of horizontal beam 139 for receiving the hitch of a towing vehicle (not shown). Two horizontal beam stabilizers 147, 149 removably attach to horizontal beam 139 and are configured to attach to both front railing 103 and crossbeam 127 via one or more fasteners.

During assembly, horizontal beam 139 is configured to slide through flanges 141, 143 and is thereafter secured into a desired position with the horizontal beam stabilizers 147, 149. The stabilizers are then secured in a fixed position via one or more fasteners. The stabilizers provide significant advantages, namely, they are configured to add additional rigidly and support; however, it will be appreciated that alternative embodiments could include a single horizontal beam without stabilizers.

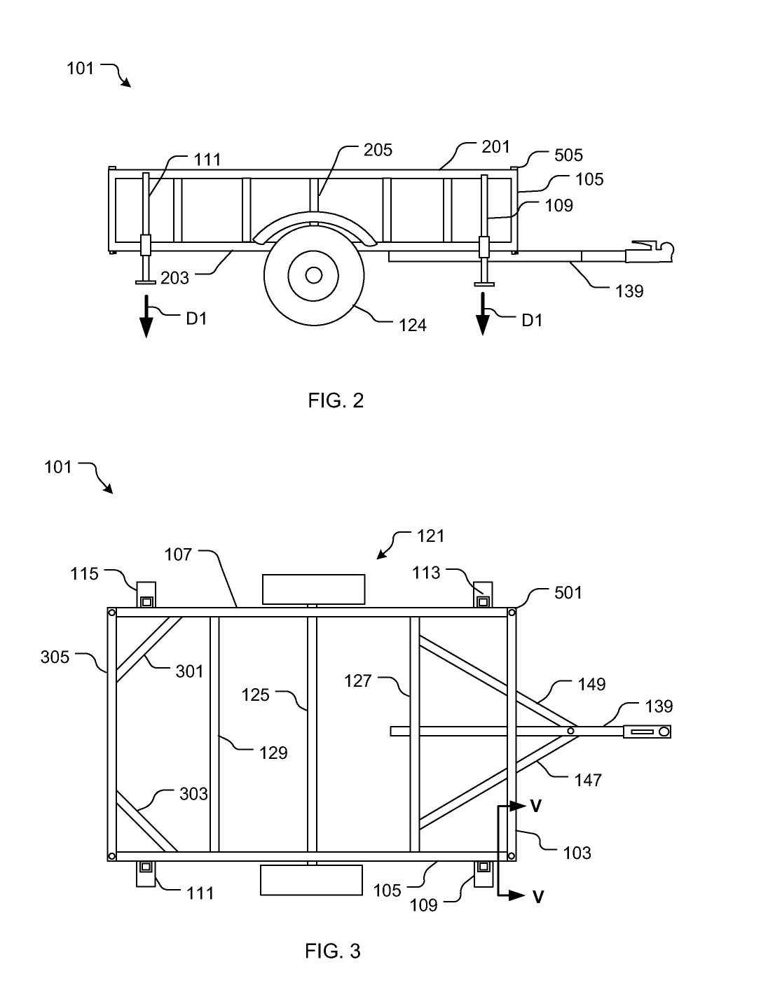

Referring specifically to FIG. 2, a side view of trailer 101 is shown. First side railing 105 preferably includes a top horizontal beam 201, a bottom horizontal beam 203 that runs relatively parallel to the top beam 201, and a plurality of vertical members 205 that space the horizontal beams relative to each other. It will be appreciated that both front railing and second side railing share the same features of first side railing 105, specifically, an upper and lower horizontal beam rigidly attached to a plurality of vertical beam members.

FIG. 3 illustrates a top view of trailer 101 without the platform. As shown, two optional horizontal crossbeam stabilizers 301, 303 removably attached to the side railings and to a back railing 305. It should be understood that back railing is optional and includes the same features as one or more of the railing discussed herein. The crossbeam stabilizers provide additional rigidly and support during use and like the horizontal stabilizers 147, 149, are optional features.

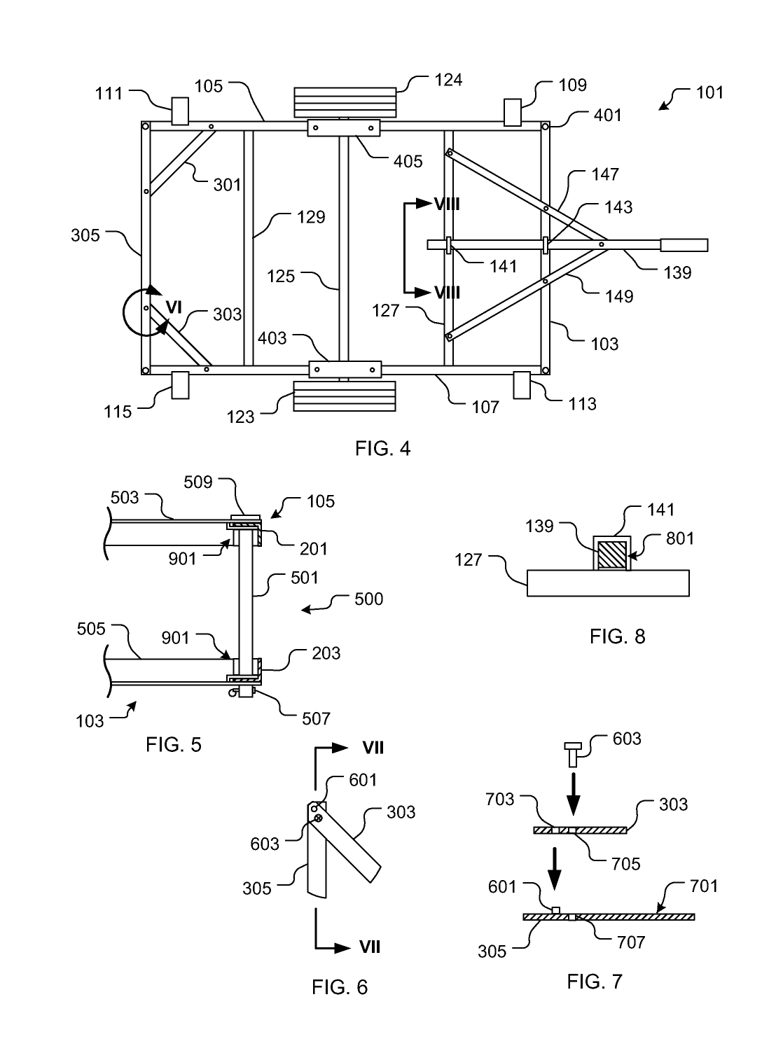

FIG. 4 illustrates a bottom view of trailer 101 without the platform. A plurality of fasteners 401 (indicated with a circle) are illustrated at various locations wherein two or more members, e.g., the side and front railings of trailer 101 are joined. In the contemplated embodiment, two types of fasteners are utilized, for example, a quick-release device that extends the entire length of a railing and configured to rapidly join two railings and a bolt fastener 603 configured to pass through a hole extending through two or more members. For ease of illustration and description, only one of the plurality of fasteners are identified.

Two leaf springs 403, 405 operably associated with axial 125 are shown attached to side railing 105, 107 via a plurality of fasteners. In the contemplated embodiment, the leaf springs are rigidly attached to the axial and are the sole member removably attached to the side railings. This feature allows rapid removal of the wheel assembly during disassembly.

FIG. 5 illustrates a partial side view of first railing 105 joined to front railing 103 via a quick-release device 500. In the contemplated embodiment, quick-release device 500 is a pin 501 that joins the two railings together. First side railing 105 includes a top horizontal beam 503 and a bottom horizontal beam 505 that run parallel to each other. Pin 501 is configured to extend through a hole at the locking mechanisms 900 and 901 and is secured in location via a pin lock 507 and via the head 509.

The quick-release device provides significant advantages, namely, the two railings are rapidly joined together and secured in position by the process of aligning the two railing and then sliding the pin through the hole created by the locking mechanisms. It will be appreciated that the quick-release device can be utilized at any location where two or more members are joined, but preferably at positions wherein the railings join.

FIG. 6 is a top view of the crossbeam horizontal stabilizer 303 and back railing 305 taken at VI-VI of FIG. 4. One unique feature believed characteristic of the present application is utilizing a plurality of alignment devices 601 at locations where two members are joined via a fastener 603 or quick-release device 500. In the contemplated embodiment, the alignment device provides rapid means to ensure that the two members are in the correct position prior to securing the members via a fastener or quick-release device.

FIG. 7 is a cross-sectional view of FIG. 6 taken at VII-VII. FIG. 7 illustrates alignment device 601 and fastener 603 operably associated with each other during the assembly process. In the contemplated embodiment, device 601 is a rod that protrudes from surface 701 of railing 305 and is received within a hole 703 that extends through at least partially through the thickness of stabilizer 303. Aligning the rod through the hole aligns a first hole 705 extending through the thickness of stabilizer 303 with a second hole 707 extending through the thickness of railing 305. The alignment of the two holes 705, 707 provides access for a fastener 603 to pass through the two members.

FIG. 8 is a front view of crossbeam 127 and a cross-sectional front view of beam 139 taken at VIII-VIII of FIG. 4. As depicted, flange 141 creates an area 801 that allows beam 139 to slide therethrough. Flange 141 effectively assists in the assembly process and creates additional rigidly and support during use of trailer 101.

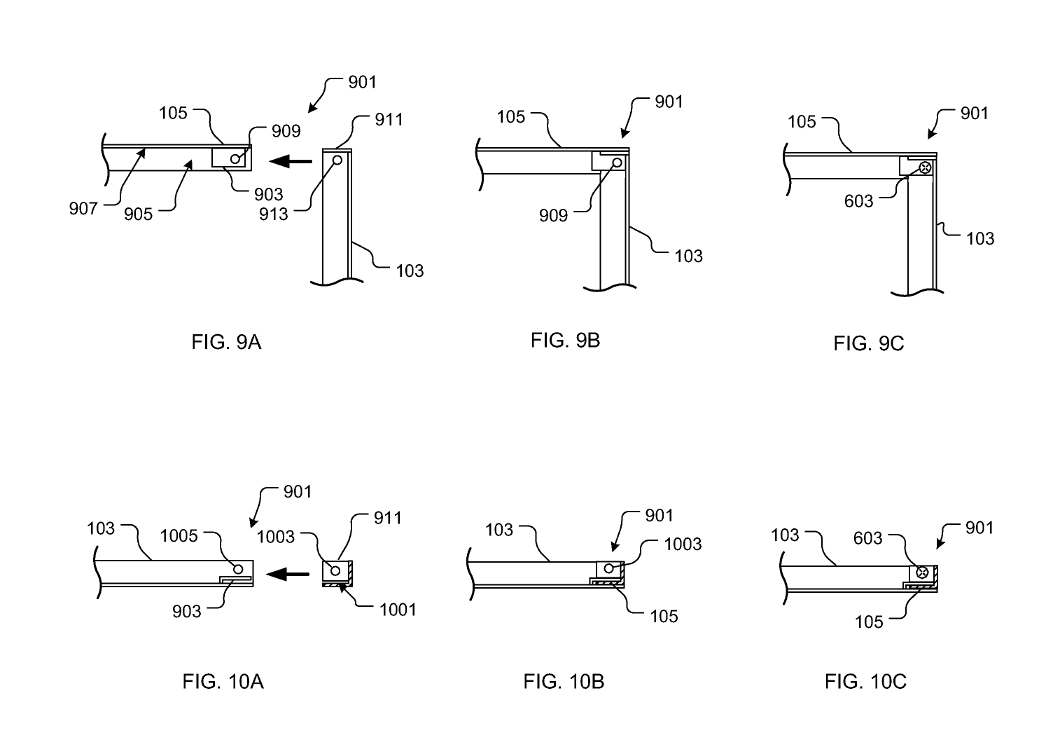

Referring next to FIGS. 9-10 of the drawing, respective top and side views of locking mechanism 901 are shown. Locking mechanism 901 includes a flange 903 that extends from a top surface 905 of railing 103. In the contemplated embodiment, railing 103 is formed of angle iron, thereby creating a second contact surface 907 relatively perpendicular to surface 905. A hole 909 extends through flange 903 and thorough the thickness of railing 103.

Side railing 105 includes a member 911 that matingly engages with flange 903. In particular, member 911 includes a slot 1001 that receives the flange. During assembly, a hole 913 extending through a thickness of railing 105 aligns with hole 909, which in turn the quick-release device 500 or a fastener 603 is passed therethrough.

Railing 105 further includes a hole 1003 that extend through member 911 and configured to align with a hole 1005 extending through the thickness of railing 103. When aligned, holes 1003, 1005 provide access for a quick-release device or a fastener 603 to pass therethrough.

The locking mechanism 901 utilizes one or more of a flange, surfaces, holes, fasteners, quick-release devices, and the like to prevent slipping and to add additional stability and rigidly between joining parts. The locking mechanism is also uniquely characterized because of its ability to quickly and rapidly align the member and thereafter secure the members via the fasteners.

Although not shown in the figures, alternative embodiments could include an electrical system, e.g., tail lights that removably attach to one or more members of trailer 101. It is contemplated that the electrical systems could be removably attached via a hook-loop system, a plurality of clips, and the like. Also, alternative embodiments could include storage racks tailored to store the railing and/or other members of the trailer.

A method to assemble trailer 101 includes the process of joining the front railing to both side railings via one or more fasteners or preferably quick-release devices. Thereafter, the railings are raised via the footing to the desired height. The wheel assembly is then fastened to the side railings. The process is continued by attaching the remaining members, including the horizontal beam, stabilizers, crossbeams, and finally the platform.

It is apparent that a trailer and method with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A trailer, comprising:
a first side railing, having:
a first stand and a second stand;
a second side railing, having:
a third stand and a fourth stand;
a front railing removably attached to the first side railing and the second side railing, the front railing be configured to retain the first side railing and the second side railing relatively parallel to each other;
a wheel assembly removably attached to the first side railing and the second side railing;
wherein, during assembly, the first stand, the second stand, the third stand, and the fourth stand are configured to raise the first side railing, the front railing, and the second side railing relative to a ground surface; and
wherein the wheel assembly is configured to removably attach to the first side railing and the second side railing as the first side railing, the front railing, and the second side railing are raised.

2. The trailer of claim 1, further comprising:
a crossbeam removably attached to the first side railing and the second side railing;
wherein the crossbeam is configured to retain the first side railing and the second side railing in a position relatively parallel to each other.

3. The trailer of claim 2, further comprising:
a platform removably attached to the crossbeam.

4. The trailer of claim 3, wherein the platform bifurcates into two sections pivotally joined together via a pivot joint.

5. The trailer of claim 2, further comprising:
a horizontal beam removably attached to the crossbeam and the front railing.

6. The trailer of claim 5, further comprising:
a horizontal beam stabilizer removably attached to the horizontal beam and the front railing.

7. The trailer of claim 5, further comprising:
a flange rigidly attached to the crossbeam and configured to receive the horizontal beam.

8. The trailer of claim 1, further comprising:
a fastener configured to removably attach and secure the front railing to the first sidewall.

9. The trailer of claim 1, wherein:
the first side railing, comprises:
a top horizontal beam; and
a bottom horizontal beam running relatively parallel to the top horizontal beam; and
the front railing, comprises:
an upper horizontal beam; and
a lower horizontal beam running relatively parallel to the top horizontal beam.

10. The trailer of claim 9, further comprising:
a quick-release device configured to simultaneously join the top horizontal beam to the upper horizontal beam and to join the bottom horizontal beam to the lower horizontal beam.

11. The trailer of claim 10, wherein the quick-release device is a pin configured to pass through a first hole that extend through a thickness of the top horizontal beam and the upper horizontal beam, and to pass through a second hole that extend through a thickness of the bottom horizontal beam and the lower horizontal beam.

12. The trailer of claim 9, further comprising:
a locking mechanism configured to interlock the bottom horizontal beam to the lower horizontal beam.

13. The trailer of claim 12, wherein the locking mechanism is a flange rigidly attached to the bottom horizontal beam and configured to receive the lower horizontal beam.

14. The trailer of claim 13, further comprising:
a hole extending through a thickness of the flange;
a quick-release device configured to pass through the hole and to securely join the bottom horizontal beam to the lower horizontal beam.

15. The trailer of claim 9, further comprising:
an alignment device configured to align the top horizontal beam relatively perpendicular to the upper horizontal beam.

16. The trailer of claim 15, wherein the alignment device is a rod extending from a top surface of the upper horizontal beam and configured to pass through a hole extending a thickness of the top horizontal beam.

17. A trailer, comprising:
a first side railing, having:
a top horizontal beam; and
a bottom horizontal beam running relatively parallel to the top horizontal beam;
a front railing, comprises:
an upper horizontal beam; and
a lower horizontal beam running relatively parallel to the top horizontal beam; and
a quick-release device configured to simultaneously join the top horizontal beam to the upper horizontal beam and to join the bottom horizontal beam to the lower horizontal beam.

18. The trailer of claim 17, wherein the quick-release device is a pin configured to pass through a first hole that extend through a thickness of the top horizontal beam and the upper horizontal beam, and to pass through a second hole that extend through a thickness of the bottom horizontal beam and the lower horizontal beam.

19. A method to assembly a trailer, comprising:
releasably attaching a front railing with a first side railing and a second side railing;
raising the front railing, the first side railing, and the second side railing with a plurality of stands operably associated with the first side railing and the second side railing; and
releasably attaching a wheel assembly to the first side railing and the second side railing.

20. The method of claim 19, further comprising:
joining the front railing to the first side railing with a first quick-release device; and
joining the front railing to the second side railing with a second quick-release device.
